(19) United States
(12) Patent Application Publication
(10) Pub. No.: US 2014/0064359 A1
(43) Pub. Date: Mar. 6, 2014

(54) INTRA PREDICTION MOST PROBABLE MODE ORDER IMPROVEMENT FOR SCALABLE VIDEO CODING

(71) Applicant: QUALCOMM Incorporated, San Diego, CA (US)

(72) Inventors: Krishnakanth RAPAKA, San Diego, CA (US); Jewon KANG, San Diego, CA (US); Jianle CHEN, San Diego, CA (US); Marta KARCZEWICZ, San Diego, CA (US); Vadim SEREGIN, San Diego, CA (US)

(73) Assignee: QUALCOMM Incorporated, San Diego, CA (US)

(21) Appl. No.: 14/011,406

(22) Filed: Aug. 27, 2013

Related U.S. Application Data
(60) Provisional application No. 61/696,098, filed on Aug. 31, 2012.
(60) Provisional application No. 61/707,145, filed on Sep. 28, 2012.
(60) Provisional application No. 61/751,807, filed on Jan. 11, 2013.
(60) Provisional application No. 61/752,891, filed on Jan. 15, 2013.
(60) Provisional application No. 61/754,934, filed on Jan. 21, 2013.

(51) Int. Cl. H04N 7/26

(52) U.S. Cl. CPC H04N 19/00024; H04N 19/00321
USPC 375/240.02

(57) ABSTRACT

An apparatus for coding video information according to certain aspects includes a memory unit and a processor in communication with the memory unit. The memory unit stores video information associated with a reference layer and a corresponding enhancement layer. The processor receives a mode list associated with the enhancement layer, the mode list comprising three entities, each entity identifying a different mode for determining a value of a video unit located at a position within the enhancement layer. The processor changes the mode list when a mode associated with a co-located video unit in the reference layer is not stored as the first entity in the mode list. The co-located video unit is located at a position in the reference layer corresponding to the position of the video unit in the enhancement layer.

### RELATED APPLICATION

This application claims the benefit of U.S. Provisional Application No. 61/696,098, filed on Aug. 31, 2012, entitled “INTRA PREDICTION MOST PROBABLE MODE ORDER IMPROVEMENT FOR SCALABLE VIDEO CODING,” U.S. Provisional Application No. 61/707,145, filed on Sep. 28, 2012, entitled “INTRA PREDICTION MOST PROBABLE MODE ORDER IMPROVEMENT FOR SCALABLE VIDEO CODING,” U.S. Provisional Application No. 61/751,807, filed on Jan. 11, 2013, entitled “INTER LAYER INTRA MODE PREDICTION FOR ENHANCEMENT LAYER IN SCALABLE VIDEO CODING,” U.S. Provisional Application No. 61/752,891, filed on Jan. 15, 2013, entitled “INTER LAYER INTRA MODE PREDICTION (ILIMP) IMPROVEMENTS FOR ENHANCEMENT LAYER,” and U.S. Provisional Application No. 61/754,934, filed on Jan. 21, 2013, entitled, “INTER LAYER INTRA MODE PREDICTION FOR ENHANCEMENT LAYER IN SCALABLE VIDEO CODING,” which are incorporated herein by reference in their entireties.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques related to improving coding performance by conditionally changing the order of entries in a mode list, such as, but not limited to, a Most Probable Mode (MPM) list.

An apparatus for coding video information according to certain aspects includes a memory unit and a processor in communication with the memory unit. The memory unit stores video information associated with a reference layer and a corresponding enhancement layer. The processor receives a mode list associated with the enhancement layer, the mode list comprising three entities, each entity identifying a different mode for determining a value of a video unit located at a position within the enhancement layer. The processor changes the mode list when a mode associated with a co-located video unit in the reference layer is not stored as the first entity in the mode list. The co-located video unit is located at a position in the reference layer corresponding to the position of the video unit in the enhancement layer.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques in accordance with aspects described in this disclosure.

FIG. 2 is a block diagram illustrating an example of a video encoder that may implement techniques in accordance with aspects described in this disclosure.

FIG. 3 is a block diagram illustrating an example of a video decoder that may implement techniques in accordance with aspects described in this disclosure.

FIG. 4 is a block diagram illustrating an example of a video coder.

FIG. 5 illustrates various modes for intra prediction.

FIG. 6 is a block diagram illustrating a prediction process.

FIG. 7 is a block diagram illustrating a current prediction unit and its neighboring units.

FIG. 8 is a block diagram illustrating enhancement layer difference domain coding and regular pixel domain coding.

FIG. 9 is a block diagram illustrating use of neighboring values to determine difference domain prediction.

FIG. 10 is a flowchart illustrating an example method for determining most probable modes (MPMs) for intra prediction according to aspects of this disclosure.

FIG. 11 illustrates one embodiment of MPM list generation.

FIG. 12 illustrates one embodiment of modified MPM list generation at an enhancement layer according to aspects of this disclosure.

### DETAILED DESCRIPTION

The techniques described in this disclosure generally relate to scalable video coding (SVC) and 3D video coding. For example, the techniques may be related to, and used with or within, a High Efficiency Video Coding (HEVC) scalable video coding (SVC) extension. The HEVC SVC extension may also be referred to as Scalable HEVC (SHVC). In an SVC extension, there could be multiple layers of video information. The layer at the very bottom level may serve as a base layer (BL), and the layer at the very top may serve as an enhanced layer (EL). The “enhanced layer” is sometimes referred to as an “enhancement layer,” and these terms may be used interchangeably. All layers in the middle may serve as either or both ELs or BLs. For example, a layer in the middle may be an EL for the layers below it, such as the base layer or any intervening enhancement layers, and at the same time serve as a BL for the enhancement layers above it.

For purposes of illustration only, the techniques described in the disclosure are described with examples including only two layers (e.g., lower level layer such as the base layer, and a higher level layer such as the enhanced layer). It should be understood that the examples described in this disclosure can be extended to examples with multiple base layers and enhancement layers as well.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. In addition, a new video coding standard, namely High Efficiency Video Coding (HEVC), is being developed by the Joint Collaboration Team on Video Coding (JCT-VC) of ITU-T Video Coding Experts Group (VCEG) and ISO/IEC Motion Picture Experts Group (MPEG). A recent draft of HEVC is available from http://wg11.sc29.org/jct/doc_end_user/current_document.php?id=5885/JCTVC-I1003-v2, as of Jun. 7, 2012. Another recent draft of the HEVC standard, referred to as “HEVC Working Draft 7” is downloadable from http://phenix.it-sudparis.eu/jct/doc_end_user/documents/9 Geneva/wg11/JCTVC-I1003-v3.zip, as of Jun. 7, 2012. The full citation for the HEVC Working Draft 7 is document JCTVC-I1003, Bross et al., “High Efficiency Video Coding (HEVC) Text Specification Draft 7,” Joint Collaborative Team on Video Coding (JCT-VC) of ITU-T SG16 WP3 and ISO/IEC JTC1/SC29/WG11, 9^{th} Meeting: Geneva, Switzerland, Apr. 27, 2012 to May 7, 2012. An additional recent draft of the HEVC standard, referred to as “HEVC Working Draft (WD) 8,” is available from http://phenix.int-evey.fr/jct/doc_{—}end_user/documents/10_Stockholm/wg11/JCTVC-J1003-v8.zip. Another recent working version of the HEVC standard is JCTVT-N0041. The approved HECV specification can be found at http://www.itu.int/rec/T-REC-H.265-201304-I. Each of these references is incorporated by reference in its entirety.

Scalable video coding (SVC) may be used to provide quality (also referred to as signal-to-noise (SNR)) scalability, spatial scalability and/or temporal scalability. An enhanced layer may have different spatial resolution than base layer. For example, the spatial aspect ratio between EL and BL can be 1.0, 1.5, 2.0 or other different ratios. In other words, the spatial aspect of the EL may equal 1.0, 1.5, or 2.0 times the spatial aspect of the BL. In some examples, the scaling factor of the EL may be greater than the BL. For example, a size of pictures in the EL may be greater than a size of pictures in the BL. In this way, it may be possible, although not a limitation, that the spatial resolution of the EL is larger than the spatial resolution of the BL.

HEVC provides a Most Probable Mode (MPM) list for coding intra prediction modes. The MPM list typically includes three entities. The entities indicate the most probable modes that will be used for intra prediction, and may also be referred to as modes. The early entities in the MPM list take fewer bits to code than the later entities. Therefore, it would be advantageous to list the entities in the order of most probable to least probable.

The techniques described in this disclosure may address issues relating to intra prediction in SVC. The techniques may apply to determining and/or ordering the MPM list in SVC intra prediction. The techniques may populate and/or reorganize the entities within an MPM list, for example, in order to achieve optimum rate-distortion trade-off. The MPM list may be populated and/or reorganized to list the most probable list first and the least probable list last. Because the early entities in the MPM list are coded using fewer bits, listing the most probable mode first may reduce the number of bits used to code the MPM list.

The techniques may populate and/or reorganize the entities in the MPM list in various ways. In one embodiment, a mode of a co-located unit in a reference layer (e.g., BaseLayerLumaIntraMode) may be considered as an MPM candidate for a current Prediction Unit (PU). The reference layer mode may be inserted as the first entity in the MPM list. If one of the existing MPM mode entities is the same as the reference layer mode, this entity is removed from the final MPM list. Otherwise, the last entity is removed from the final MPM list. In another embodiment, if one of the existing MPM mode entities is the same as the reference layer mode and the reference layer mode is not the DC mode, this entity is removed from the final MPM list. Otherwise, the last entity is removed from the final MPM list. If the reference layer mode is the DC mode, the reference layer mode may not be inserted into the MPM list. In yet another embodiment, the MPM mode order is prioritized based upon information from the reference layer mode. For example, a priority rule may be applied to the entities.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

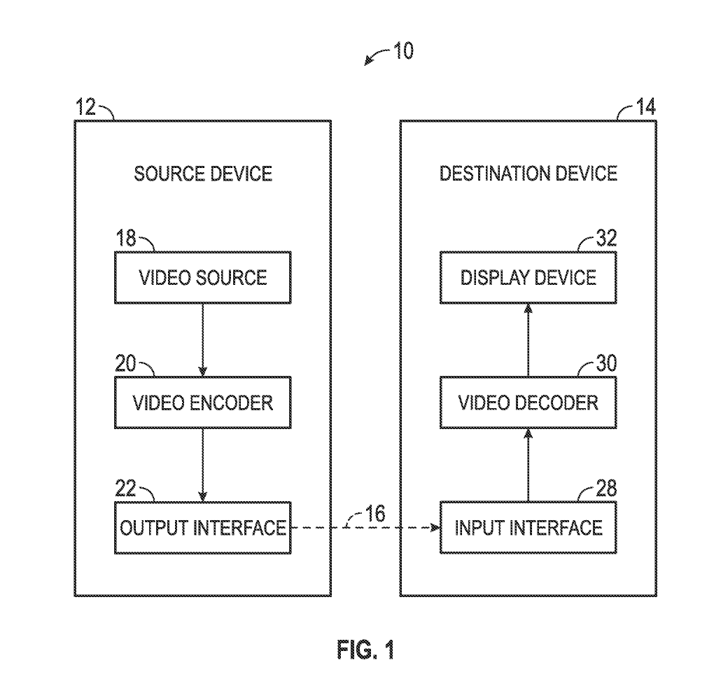

FIG. 1 is a block diagram illustrating an example video encoding and decoding system that may utilize techniques in accordance with aspects described in this disclosure. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for coding a bitstream including video data conforming to multiple standards or standard extensions. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for determining candidates for a candidate list for motion vector predictors for a current block may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission, direct wired communication, etc. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard, including but not limited to any of the standards listed above. Other examples of video coding standards include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up,” “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

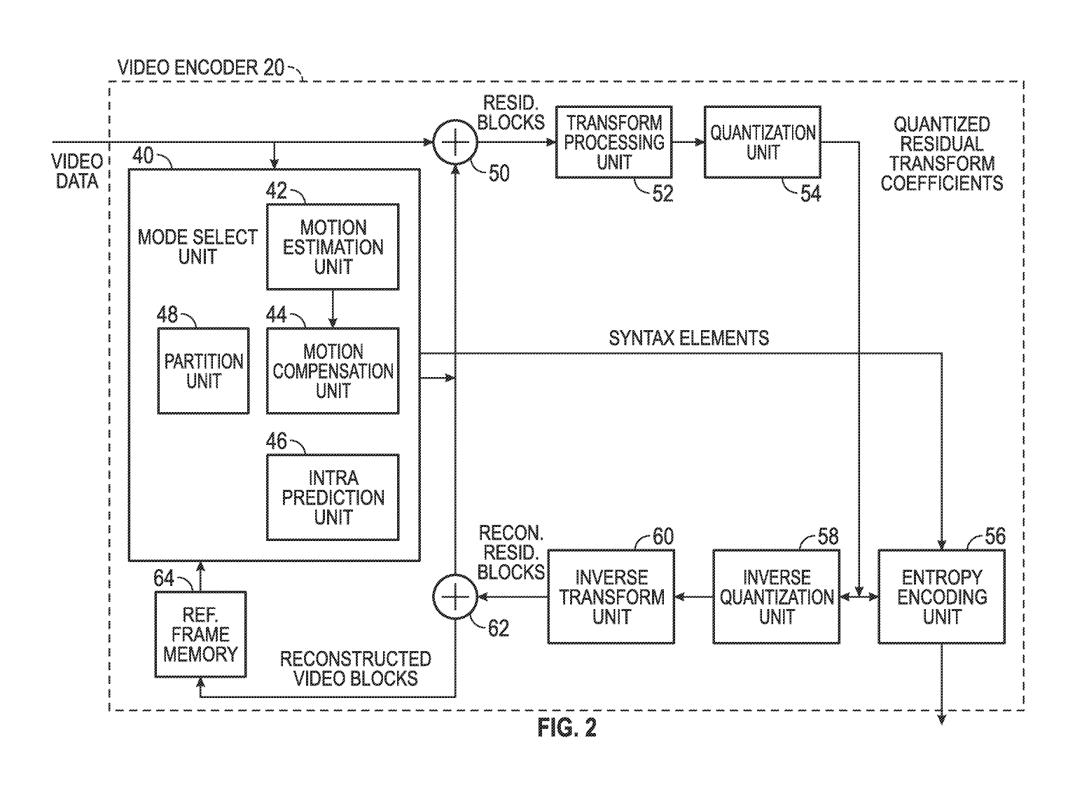

FIG. 2 is a block diagram illustrating an example of a video encoder that may implement techniques in accordance with aspects described in this disclosure. Video encoder 20 may be configured to perform any or all of the techniques of this disclosure. As one example, mode select unit 40 may be configured to perform any or all of the techniques described in this disclosure. However, aspects of this disclosure are not so limited. In some examples, the techniques described in this disclosure may be shared among the various components of video encoder 20. In some examples, in addition to or instead of, a processor (not shown) may be configured to perform any or all of the techniques described in this disclosure.

In some embodiments, the mode select unit 40, the intra prediction unit 46 (or another component of the mode select unit 40, shown or not shown), or another component of the encoder 20 (shown or not shown) may perform the techniques of this disclosure. For example, the mode select unit 40 may receive video data for encoding, which may be encoded into a reference layer (e.g., base layer) and corresponding one or more enhancement layers. The mode select unit 40, the intra prediction unit 46, or another appropriate unit of the encoder 20 may determine or receive a mode list associated with the enhancement layer. The mode list can include three entities, each entity identifying a different mode for determining a value of a video unit located at a position within the enhancement layer. The mode select unit 40, the intra prediction unit 46, or another appropriate unit of the encoder 20 can change the mode list when a mode associated with a co-located video unit in the reference layer is not stored as the first entity in the mode list. The co-located video unit is located at a position in the reference layer corresponding to the position of the video unit in the enhancement layer. The encoder 20 can encode data relating to the video unit and signal the encoded data in a bitstream. The encoder 20 can also encode the mode list and signal the mode list in a bitstream.

Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 1, video encoder 20 includes mode select unit 40, reference frame memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

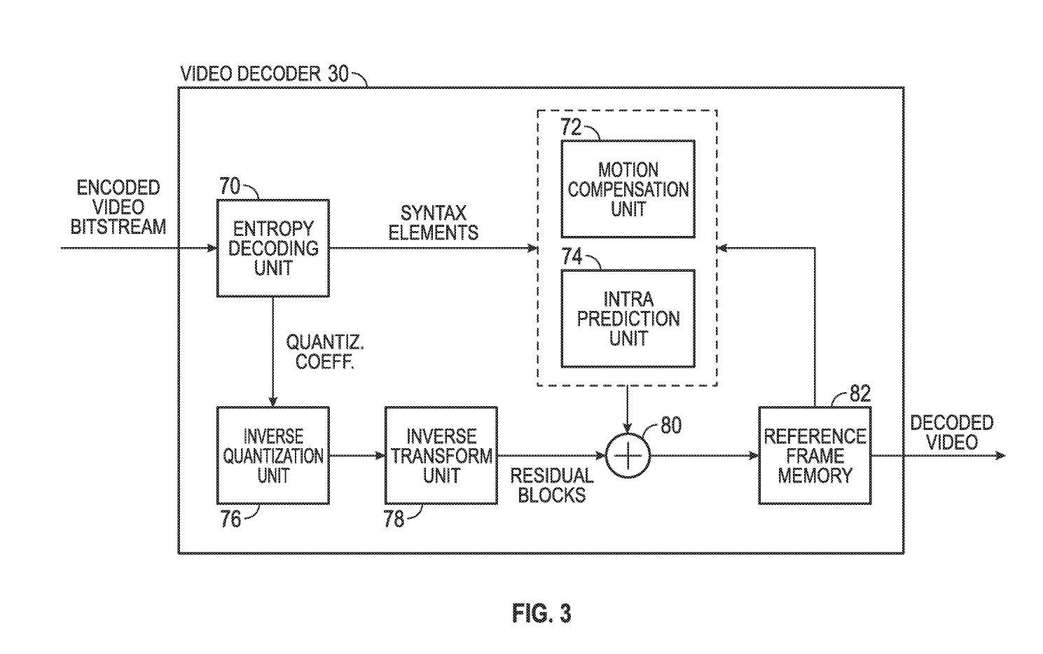

FIG. 3 is a block diagram illustrating an example of a video decoder that may implement techniques in accordance with aspects described in this disclosure. Video decoder 30 may be configured to perform any or all of the techniques of this disclosure. As one example, motion compensation unit 72 and/or intra prediction unit 74 may be configured to perform any or all of the techniques described in this disclosure. However, aspects of this disclosure are not so limited. In some examples, the techniques described in this disclosure may be shared among the various components of video decoder 30. In some examples, in addition to or instead of, a processor (not shown) may be configured to perform any or all of the techniques described in this disclosure.

In some embodiments, the entropy decoding unit 70, the intra prediction unit 74, or another component of the decoder 30 (shown or not shown) may perform the techniques of this disclosure. For example, the entropy decoding unit 70 may receive an encoded video bitstream, which may encode data relating to a reference layer (e.g., base layer) and corresponding one or more enhancement layers. The intra prediction unit 74 or another appropriate unit of the decoder 30 may receive a mode list associated with the enhancement layer. The mode list can include three entities, each entity identifying a different mode for determining a value of a video unit located at a position within the enhancement layer. The intra prediction unit 74 or another appropriate unit of the decoder 30 can change the mode list when a mode associated with a co-located video unit in the reference layer is not stored as the first entity in the mode list. The co-located video unit is located at a position in the reference layer corresponding to the position of the video unit in the enhancement layer. The entropy decoding unit 70 or another component of the decoder 30 may be configured to decode the video unit and to receive the mode list in a bitstream.

In the example of FIG. 3, video decoder 30 includes an entropy decoding unit 70, motion compensation unit 72, intra prediction unit 74, inverse quantization unit 76, inverse transformation unit 78, reference frame memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (e.g., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 92. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, e.g., de-quantizes, the quantized transform coefficients provided in the bitstream and decoded by entropy decoding unit 80. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference frame memory 82 also stores decoded video for later presentation on a display device, such as display device 32 of FIG. 1.

Video Coding Overview

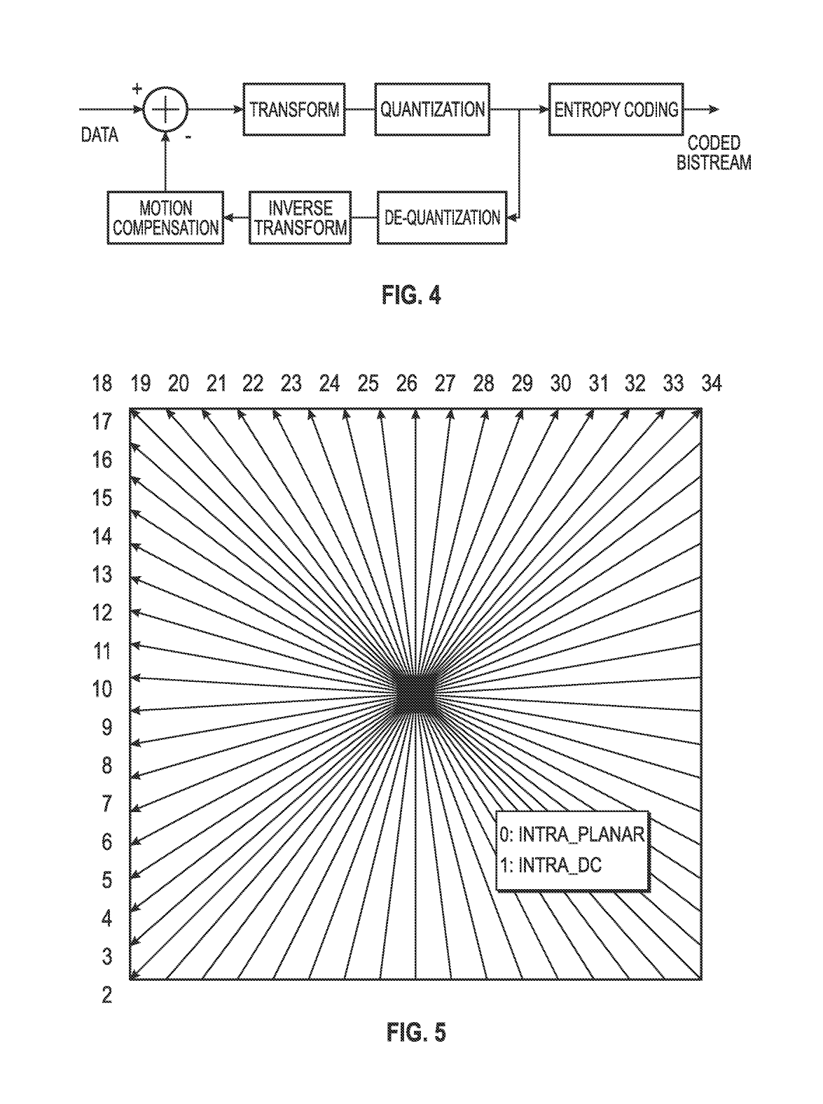

In one embodiment, a video coder is configured to implement four coding techniques as shown in FIG. 4, including motion prediction, transform, quantization, and entropy coding. These techniques may be applied to rectangular blocks and/or regions of the frame, such as, but not limited to, a Coding Unit, etc.

A video signal can have temporal redundancy, with high correlation between neighboring frames. Additionally within a frame, image, etc., data can sometimes have spatial redundancy among neighboring pixels. In some situations, a Coding Unit can be configured to take advantage of such spatial redundancy by predicting from spatially located neighboring pixels. In such situations, the CU may be coded as an Intra mode Coding Unit. In other situations, the data can sometimes have temporal redundancy among neighboring frames. In some situations, a CU can be configured to take advantage of such temporal redundancy by predicting motion from neighboring frames. In such situations, the CU may be coded as an Inter mode Coding Unit. The prediction stage is generally loss-less. Coded blocks may then be transformed using any one or more of a variety of techniques, e.g., DCT, etc., to de-correlate signals so that the outputs can be efficiently coded using techniques such as scalar quantization, etc. Further these quantized coefficients may be compressed using entropy coding techniques, such as Arithmetic coding, etc.

In general, coding units encoded in P/B-mode are predicted from one or more of the previously coded frames. For these modes the prediction information of a block is represented by a two-dimensional (2D) motion vector. For the blocks encoded in I-mode, the predicted block is formed using spatial prediction from already encoded neighboring blocks within the same frame. The prediction error, e.g., the difference between the block being encoded and the predicted block is then transformed and quantized. The quantized transform coefficients, together with motion vectors and other control information, form a coded sequence representation and are sometimes referred to as syntax elements. Prior to transmission from the encoder to the decoder, all syntax elements may be entropy coded so as to further reduce the number of bits utilized for their representation.

In the decoder, the block in the current frame is obtained by first constructing its prediction in the same manner as in the encoder and by adding to the prediction the compressed prediction error.

HEVC Intra Prediction

An intra prediction mode is often used in HEVC to take advantage of existing spatial correlation. HEVC provides 35 modes for all blocks size. FIG. 5 illustrates the 35 modes for intra prediction.

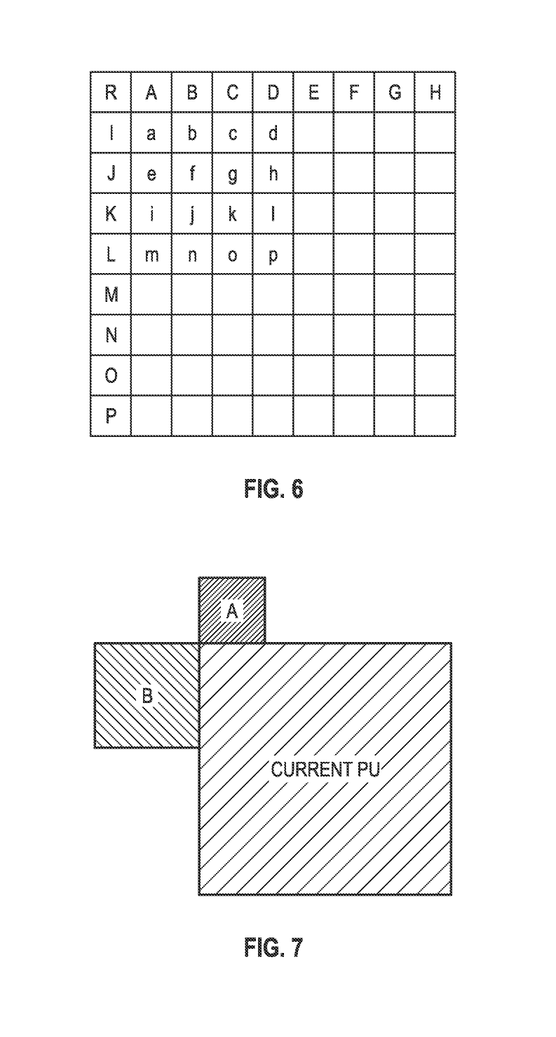

One embodiment of a prediction process is illustrated in FIG. 6. As shown in FIG. 6, pixels “a” to “p” are to be encoded. Pixels “A” to “R” are located in neighboring blocks, and have already been encoded. The neighboring pixels are used for prediction to predict the values of the “a” to “p” pixels. Pixels “A” to “R” may be referred to a neighboring pixels.

If, for example, Mode Vertical is selected, then pixels a, e, i and m are predicted by setting them equal to pixel A, and pixels b, f, j and n are predicted by setting them equal to pixel B, etc. Similarly, if Mode Horizontal is selected, pixels a, b, c and d are predicted by setting them equal to pixel I, and pixels e, f, g and h are predicted by setting them equal to pixel J, etc.

Present Most Probable Mode derivation in HEVC Base Layer

FIG. 7 illustrates one embodiment of a current prediction unit (PU) and neighboring units, “A” and “B.” The following describes one embodiment of Most Probable Mode list derivation in an HEVC base layer.

```
• intraPredModeA = intraPredModeB
    - If intraPredModeA < 2
        • candModeList[0] = Intra_Planar
        • candModeList[1] = Intra_DC
        • candModeList[2] = Intra_Angular (26), (Vertical)
    - Otherwise,
        • candModeList[0] = candIntraPredModeA
        • candModeList[1] = 2 + ( ( candIntraPredModeA − 2 − 1)
            % 32, (closest mode)
        • candModeList[2] = 2 + ( ( candIntraPredModeA − 2 + 1)
            % 32, (closest mode)
• intraPredModeA != intraPredModeB
    - candModeList[0] = intraPredModeA
    - candModeList[1] = intraPredModeB
    - If intraPredModeA!= Intra_Planar AND intraPredModeB!=
      Intra_Planar
        • candModeList[2] = Intra_Planar
    - Otherwise, if intraPredModeA!= Intra_DC AND
      intraPredModeB!= Intra_DC
        • candModeList[2] = Intra_DC
    - Otherwise
        • candModeList[2] = Intra_Angular (26), (Vertical)
```

HEVC Scalable Video Coding Extension

The SVC (Scalable Video Coding) extension to the HEVC codec standard allows sending and receiving multi-layered video streams. The multi-layered video streams may include a small base layer and one or more optional additional layers that can be used to enhance resolution, frame rate and quality.

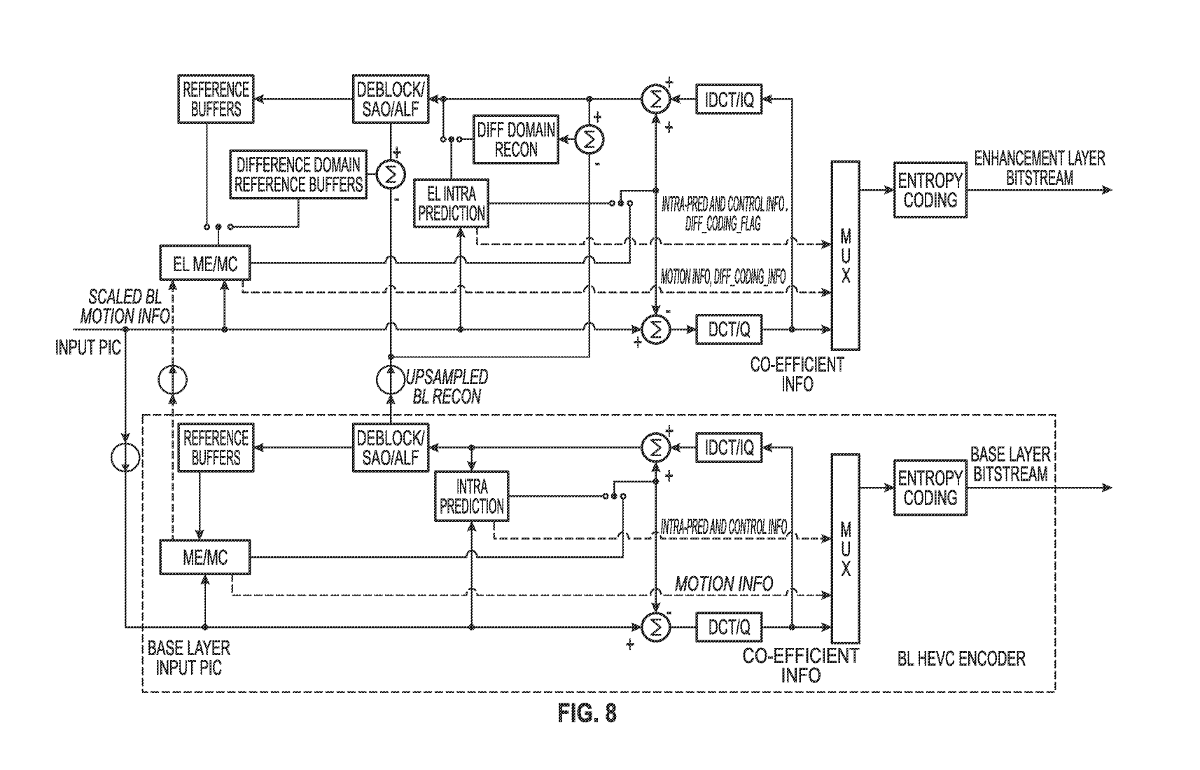

FIG. 8 illustrates one embodiment of enhancement layer difference domain coding and regular pixel domain coding

Difference Domain Intra Prediction Coding

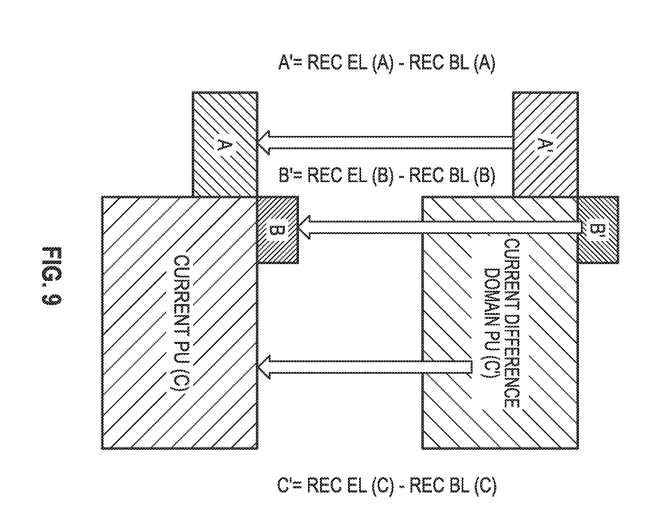

Difference domain coding intra prediction is sometimes implemented by subtracting a current layer picture samples from a corresponding Base Layer reconstructed picture sample (or upsampled reconstructed picture in case of spatial scalable layer). The resulting difference is used to form a “difference” signal which is further predicted from neighboring difference signal. The difference may be encoded, which often results in better coding efficiency. One embodiment of using neighboring values to determine difference domain prediction is illustrated in FIG. 9.

In one embodiment, a difference domain prediction flag is provided to the decoder to indicate whether difference domain was used. To improve compression efficiency, difference domain prediction can be performed at any granularity level, including those described in the HEVC Compression Draft, including but not limited to frame, slice, LCU, CU, PU, etc. Difference domain prediction flag information may be signaled at any such granularity level.

Base Layer Luma Direction Mode as a Luma MPM Candidate for EL Prediction

HEVC provides a Most Probable Mode list for coding intra prediction modes. There are typically three entities in the list. The entities indicate the most probable modes that will be used for EL prediction. The early entries in the MPM list take fewer bits to code than the later entries. Therefore, in one embodiment, to reduce the number of bits used to code the MPM list, early entries of the MPM list are populated in order from most to least probable modes. In the embodiments described below, various methods of populating and/or reorganizing the entities within an MPM list are provided. Such techniques can help achieve best rate-distortion trade-off

The Most Probable Mode (MPM) list provides a list of the most probable modes for intra prediction. The MPM list generally includes three most probable modes, with the most probable mode listed first, and the least probable mode listed last.

In one embodiment, a mode of a co-located unit in a base layer (e.g., BaseLayerLumaIntraMode) is considered as an MPM candidate for a current PU. After an initial Luma MPM list is derived (e.g., with the process of single layer HEVC), the co-located unit's mode (e.g., BaseLayerLumaIntraMode) is inserted as the first candidate in the Luma MPM list and one existing candidate in the initial MPM list is removed. In general, if any one of the existing MPM modes for the current unit is the same as the mode of the co-located BL unit (e.g., modeBaseLayerLumaIntraMode), the existing duplicate mode is removed from the MPM list such that the candidate mode becomes the first entity in the list; otherwise, the last MPM candidate is removed from the final MPM list. One embodiment of a method of processing an MPM list is:

| | |
|---|---|
| If ColBaseLayerIntraMode != candModeList[0] | AND |
| ColBaseLayerIntraMode != candModeList[1] | AND |

ColBaseLayerIntraMode != candModeList[2]
{
• candModeList[2] = candModeList[1]
• candModeList[1] = candModeList[0]
• candModeList[0] = ColBaseLayerIntraMode
}

Refrain from Using Base Layer Luma Direction Mode as a MPM Candidate for EL Prediction if in DC Mode

In one embodiment, if one of the existing MPM mode entities is the same as BaseLayerLumaIntraMode and if BaseLayerLumaIntraMode is not a DC Mode, this mode is removed from the final MPM list; otherwise, the last MPM candidate is removed from the final MPM list. One embodiment of processing an MPM list is:

IF ColBaseLayerIntraMode != candModeList[0] AND
IF ColBaseLayerIntraMode != candModeList[1] AND
IF ColBaseLayerIntraMode != candModeList[2] AND
IF ColBaseLayerIntraMode != DC_MODE
{
• candModeList[2] = candModeList[1]
• candModeList[1] = candModeList[0]
• candModeList[0] = ColBaseLayerIntraMode
}

For example, if the base layer mode is DC Mode, the base layer mode may not be inserted into the MPM list.

Using Base Layer Luma Direction Mode for Prioritizing MPM List Entities for EL Intra Prediction

In one embodiment, MPM mode order is prioritized based upon the information from the Base Layer mode. Even if the co-located BaseLayerLumaIntraMode already exists in the MPM list, the method uses this information to prioritize entities of the MPM. In one embodiment, a priority rule is applied to the entities. Entities in the list are coded with fewer bits the closer their position is to the first position in the list. Therefore, the prioritizing process provides a coding gain, if the process appropriately moves the entities. Another embodiment of a method of prioritizing a list is provided below.

For example, if ColBaseLayerIntraMode is same as one of the three MPM modes, this mode is prioritized and stored as the first candidate or entity in the Luma MPM list and other MPM modes are de-prioritized, or moved down the list to a lower position (e.g., shifted down) in the same order from the final MPM list. One embodiment of processing an MPM list is:

| | |
|---|---|
| If ColBaseLayerIntraMode != candModeList[0] | AND |
| ColBaseLayerIntraMode != candModeList[1] | AND |

ColBaseLayerIntraMode != candModeList[2]
{
• candModeList[2] = candModeList[1]
• candModeList[1] = candModeList[0]
• candModeList[0] = ColBaseLayerIntraMode
}
Otherwise if ColBaseLayerIntraMode == candModeList[1]
{
• candModeList[1] = candModeList[0]
• candModeList[0] = ColBaseLayerIntraMode
}
Otherwise if ColBaseLayerIntraMode == candModeList[2]
{
• candModeList[2] = candModeList[1]
• candModeList[1] = candModeList[0]
• candModeList[0] = ColBaseLayerIntraMode
}

In another embodiment, if BaseLayerLumaIntraMode is not a DC Mode:

| | |
|---|---|
| If ColBaseLayerIntraMode != candModeList[0] | AND |
| ColBaseLayerIntraMode != candModeList[1] | AND |
| ColBaseLayerIntraMode != candModeList[2] | AND |

ColBaseLayerIntraMode != DC_MODE
{
• candModeList[2] = candModeList[1];
• candModeList[1] = candModeList[0]
• candModeList[0] = ColBaseLayerIntraMode
}
Otherwise if ColBaseLayerIntraMode == candModeList[1]
{
• candModeList[1] = candModeList[0]
• candModeList[0] = ColBaseLayerIntraMode
}
Otherwise if ColBaseLayerIntraMode == candModeList[2]
{
• candModeList[2] = candModeList[1]
• candModeList[1] = candModeList[0]
• candModeList[0] = ColBaseLayerIntraMode
}

The mode list prioritization method can be applied to a variety of modes, and is not limited to the particular variable and modes discussed above, including those in the pseudocode provided herein. The method can apply to other video data information, (e.g., information other than Luma information), as well.

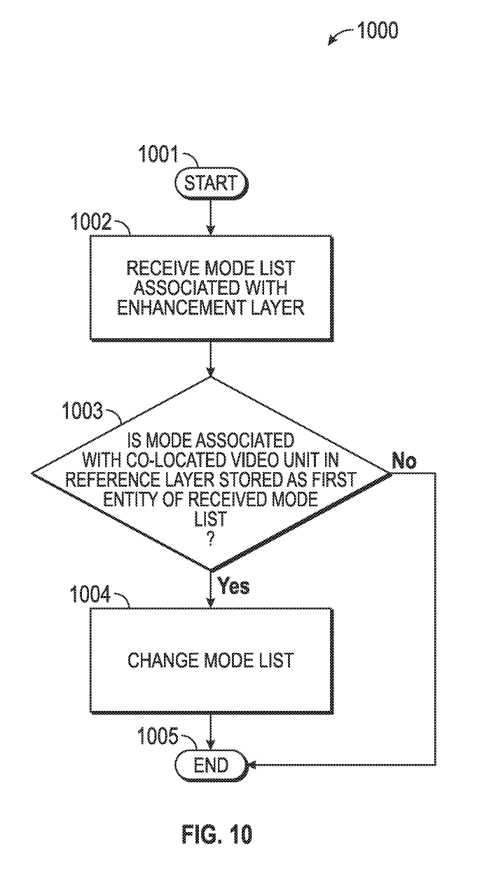

FIG. 10 is a flowchart illustrating an example method for determining most probable modes (MPMs) for intra prediction according to aspects of this disclosure. The process 1000 may be performed by an encoder (e.g., the encoder as shown in FIG. 2, etc.) or a decoder (e.g., the decoder as shown in FIG. 3, etc.). The blocks of the process 1000 are described with respect to the encoder 20 in FIG. 2, but the process 1000 may be performed by other components, such as a decoder, as mentioned above. The process 1000 may generally apply to intra prediction in SVC. The process 1000 may also be applicable to intra prediction in the difference domain. All embodiments described with respect to FIG. 10 may be implemented separately, or in combination with one another.

The process 1000 begins at block 1001. At block 1002, the encoder 20 receives a mode list associated with an enhancement layer. The mode list may be a Most Probable Mode (MPM) list. The mode list may include three entities, where each entity identifies a different mode for determining a value of a video unit located at a position within the enhancement layer. A mode may be any mode used in intra prediction. Examples of intra prediction modes may include, but are not limited to: vertical mode, horizontal mode, DC mode, planar mode, angular mode, etc. A video unit may be any unit of video data, and can include but is not limited to: a frame, a slice, a largest coding unit (LCU), a coding unit (CU), a block, a pixel, and a sub-pixel. The value of the video unit may be determined by generating a prediction unit (PU) for the video unit.

At block 1003, the encoder 20 determines if a mode associated with a co-located video unit in the reference layer is stored as the first entity in the mode list. The reference layer may be a base layer. The co-located video unit in the reference layer may be located at a position in the reference layer corresponding to the position of the video unit in the enhancement layer. If the mode associated with the co-located video unit in the reference layer is stored as the first entity of the mode list, the process 1000 proceeds to block 1004; otherwise, the process 1000 proceeds to block 1005, where the process 1000 ends.

At block 1004, the mode list is changed. The mode list may be changed by shifting the mode list entities and storing the mode of the co-located video unit as the first entity in the mode list. The mode list may also be changed by swapping the position of the mode associated with the co-located video unit in the mode list with the first entity in the mode list. The mode list may also be changed according to a priority that is determined based at least in part on the mode associated with the co-located video unit. In some embodiments, the encoder 20 may change the mode list when the mode associated with the co-located video unit in the reference layer is not stored in the mode list. In other embodiments, the encoder 20 may change the mode list when the mode associated with the co-located video unit is stored as the second or third entity of the mode list. The encoder 20 may change the mode list at any coding level, including, but not limited to: a sequence, a group of frames, a frame, a group of slices, a slice, a group of coding units (CUs), a coding unit (CU), a group of prediction units (PUs), a prediction unit (PU), blocks, a region of pixels, a pixel, etc.

In some embodiments, the encoder 20 refrains from changing the mode list when the mode associated with the co-located video unit is in the mode list. Refraining from changing the mode list may refer to, e.g., not changing the mode list.

In some embodiments, the encoder 20 refrains from changing the mode list when the mode associated with the co-located video unit is a DC mode. The DC mode may refer to a mode in which an average of video unit values in the reference layer is used to determine the video unit value in the enhancement layer. Refraining from changing the mode list when the mode associated with the co-located video unit is a DC mode may refer to, e.g., not changing the mode list when the mode for the co-located video unit is the DC mode.

Intra Prediction Modes

Typically, the intra prediction modes of an enhancement layer (EL) and its co-located base layer (BL) are correlated. Therefore, BL mode information can often be used at the EL to achieve better coding efficiency (e.g., better coding efficiency of the EL). In some cases, BL mode information is coded based on the information indicating whether the EL and BL modes are the same or different. In JCTVC-K0238 and JCTVC-L0156, a flag, called intra_bl_mode_flag was introduced before rev_intra_luma_pred_flag in the coding unit syntax. If intra_bl_mode_flag is true, prev_intra_luma_pred_flag and rem_intra_luma_pred_mode do not need to be coded and the EL mode is determined (e.g., inferred) from the base layer mode; otherwise, most probable mode (MPM) coding, as in the single layer HEVC coding, is performed.

When intra_bl_mode_flag is set to true, the intra prediction mode for the enhancement layer is determined (e.g., inferred) from a base layer mode; however, in some cases, the base layer intra mode may not be available. The unavailability may be due to many reasons, such as but not limited to: (1) the BL mode is not an intra mode; (2) the co-located BL may be Constrained Intra Prediction mode, etc. If the BL is unavailable, intra_bl_mode_flag should be set to false.

In one embodiment, when base layer intra mode is not available, the base layer intra mode is set to a default intra mode direction. For example, the base layer intra mode may be set to DC mode by default when Intra BL Intra mode is not available. In another example, the default is set as planar mode.

In another embodiment, when performing any of the methods above, the infra_bl_mode_flag flag is signaled even when base layer mode is unavailable. The flag may be set as either zero or one, for example, based on the best coding-rate-to-distortion (sometimes referred to as rate-to-distortion or R-D) trade-off. All embodiments described may be implemented separately, or in combination with one another.

Inter Layer Intra Mode Prediction Improvement for EL in Scalable Video Coding

In some embodiments, it is assumed that BL mode information corresponds to the collocated CU and/or PU's BL mode information. The collocated CU and/or PUs could be either top-left, center, or bottom right of the BL coding unit.

Various embodiments are described below for inter layer intra mode prediction for EL. All embodiments described below may be implemented separately, or in combination with one another.

Embodiment 1: Base layer mode information can be used for EL only when BL mode is one of the angular modes defined in HEVC WD8.

Embodiment 2: Along with base layer mode information, the adjacent and/or neighboring mode information of the base layer mode information may be used for EL. For example, the adjacent and/or neighboring mode information may be BL mode+1 and BL mode−1. The adjacent and/or neighboring mode of BL may be defined as 1) BL ModeA and 2) BL ModeB. As an example, in HEVC WD8, BL ModeA and BL ModeB are defined as:

BL ModeA=((BL Mode+29)% 32)+2;

BL ModeB=((BL Mode−1)% 32)+2;

In cases where the BL mode is equal to 0 (BL mode=0) or BL mode is equal to maximum value (BL mode=max), BL mode+1 or BL mode−1 may not be used. Accordingly, the BL mode can be wrapped around using the above equations.

Embodiment 3: For Embodiment 1-2, when base layer mode information is used for EL, no neighboring mode information from the EL is used for MPM list generation. In one example, base layer mode information, and the adjacent and/or neighboring mode information of the base layer mode information may be used for MPM list generation. The suggested BL modes can be ordered in EL MPM list as:

MPM list 0=BL Mode, MPM list 1=BL ModeA, MPM list 2=BL ModeB 1)

MPM list 0=BL Mode, MPM list 1=BL ModeB, MPM list 2=BL ModeA 2)

Embodiment 4: Alternatively, for Embodiment 1-2, base layer mode information and/or its adjacent modes can be used as an input to HEVC MPM list generation process at EL. Base layer mode information and its adjacent mode information may replace the normal inputs to MPM list generation process defined in HEVC WD8 (e.g., left and above candidates). The BL mode may be placed as the first element in the EL MPM list.

Embodiment 5: For Embodiment 1-4, if base layer mode info is not available, BL mode information is not used for EL MPM list generation, and normal HEVC MPM list generation process is performed.

Embodiment 6: For Embodiment 1-4, if base layer mode information is not an intra mode, BL mode information is not used for EL MPM list generation, and normal HEVC MPM list generation process is performed.

Embodiment 7: For Embodiment 1-6, example implementations for SHVC MPM list generation for EL are shown below:

Implementation 1:

```
If (col BL_PREDICTION == INTRA_MODE) {
    If (col_BL_Intra_mode > 1) //greater than angular {
        MPMLIST[0] = col_BL_Intra_mode;
        MPMLIST[1] = ((iColBaseDir + 29) % 32) + 2;
        MPMLIST[2] = ((iColBaseDir − 1 ) % 32) + 2;
  }
    } else // col BL_PREDICTION != INTRA_MODE {
        HEVC MPM list generation process
    }
```

Implementation 2:

```
    If ((col BL_PREDICTION is available) && col
BL_PREDICTION == INTRA_MODE) {
        If (col_BL_Intra_mode > 1) //greater than angular {
            MPMLIST[0] = col_BL_Intra_mode;
            MPMLIST[1] = ((iColBaseDir + 29) % 32) + 2;
            MPMLIST[2] = ((iColBaseDir − 1 ) % 32) + 2;
      }
    } else // col BL_PREDICTION != INTRA_MODE {
          HEVC MPM list generation process
    }
```

Embodiment 8: For Embodiment 1-6, if BL intra mode is not an angular mode, base layer mode information may be used to replace one of the EL mode inputs of MPM list generation process. An example implementation for SHVC MPM list generation for EL is shown below:

Implementation 1:

```
If (col BL_PREDICTION == INTRA_MODE) {
    If (col_BL_Intra_mode > 1) // greater than angular {
        MPMLIST[0] = col_BL_Intra_mode;
        MPMLIST[1] = ((iColBaseDir + 29) % 32) + 2;
        MPMLIST[2] = ((iColBaseDir − 1 ) % 32) + 2;
  }
else {
    iAboveIntraDir = (iColBaseDir == iLeftIntraDir) ?
    iAboveIntraDir : iLeftIntraDir;
    iLeftIntraDir = iColBaseDir;
    HEVC MPM list generation Process
}
} else // col BL_PREDICTION != INTRA_MODE {
    HEVC MPM list generation process
}
```

Embodiment 9: For Embodiment 1-6, examples may also apply similar coding, mutatis mutando, for chroma component.

Embodiment 10: Embodiments can also apply similar coding, mutatis mutando, to multi-view or 3DV extensions of HEVC and similar scalable, multi-view, or 3DV coding scenarios based on any other coding framework, e.g., H.264/AVC.

Inter Layer Intra Mode Prediction Improvement for EL in Scalable Video coding

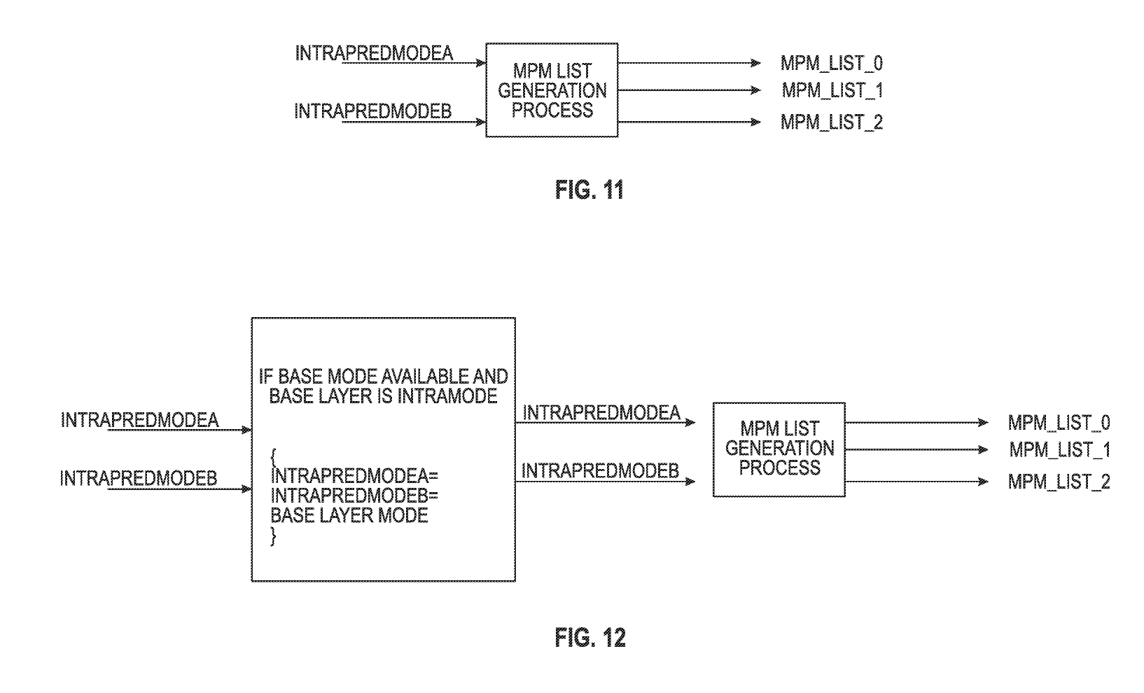

Typical HEVC intra prediction process is defined as below. MPM generation process generally takes two inputs, namely intraPredModeA and intraPredModeB, as shown in FIG. 11.

In some embodiments, the MPM process is proposed to be modified as shown in FIG. 12. The input to the MPM list may be modified and/or the MPM list generation process may be modified.

Various embodiments are described below for inter layer intra mode prediction for EL. All embodiments described below may be implemented separately, or in combination with one another.

Embodiment 1: When base layer mode information is available and base layer mode is intra mode, no neighboring mode information from the EL is used for MPM list generation. In one example, both the inputs intraPredModeA and intraPredModeB are replaced by base layer mode. For example, intraPredModeA=intraPredModeB=base layer mode.

Embodiment 2: When base layer mode information is available and base layer mode is intra mode, no neighboring mode information from the EL is used for MPM list generation. In one example, both the inputs to MPM list generation intraPredModeA and intraPredModeB are replaced by base layer mode. For example, intraPredModeA=intraPredModeB=base layer mode.

Embodiment 3: For Embodiment 1-2, the MPM list generation process in HEVC WD8 is not modified at EL.

Embodiment 4: For Embodiment 1-3, if base layer mode information is not available, BL mode information is not used for EL MPM list generation, and inputs defined in HEVC WD8 (intraPredModeA and intraPredModeB) are used. Normal HEVC MPM list generation process is performed.

Embodiment 5: For Embodiment 1-3, if base layer mode information is not intra mode, BL mode information is not used for EL MPM list generation, and inputs defined in HEVC WD8 (intraPredModeA and intraPredModeB) are used. Normal HEVC MPM list generation process is performed.

Embodiment 6: For Embodiment 1-5, an example implementation for SHVC MPM list generation for EL is shown below:

```
    If ((col BL_PREDICTION is available) && col
BL_PREDICTION == INTRA_MODE) {
        intraPredModeA = intraPredModeB = BaseLayerMode
    }
```

Embodiment 7: For Embodiment 1-6, the techniques may also apply similar coding, mutatis mutando, for chroma component.

Embodiment 8: Examples may apply similar coding, mutatis mutando, to multi-view or 3DV extensions of HEVC and similar scalable, multi-view, or 3DV coding scenarios based on any other coding framework, e.g., H.264/AVC.

Inter Layer Intra Mode Prediction Improvement for EL in Scalable Video Coding

Typical HEVC intra prediction process is defined as below. MPM generation process generally takes two inputs, namely intraPredModeA and intraPredModeB, as shown in FIG. 11.

Set forth below are several example embodiments of improved inter later intra mode prediction for an enhancement layer (EL) in SVC. The input to the MPM list may be modified and/or the MPM list generation process may be modified. It is to be recognized that such embodiments may include video encoders or decoders. All embodiments described below may be implemented separately, or in combination with one another.

Embodiment 1: In some embodiments, when base layer mode information is available and base layer mode is intra mode, only one of the neighboring mode information from the EL is used for MPM list generation. In one example, input intraPredModeA is replaced by base layer mode. For example, intraPredModeA=base layer mode. In another example, input intraPredModeB is replaced by base layer mode. For example, intraPredModeB=base layer mode.

Embodiment 2: Some embodiments may be similar to those discussed with respect to Embodiment 1. In these embodiments, alternatively, the MPM list generation process in HEVC WD is not modified at EL and is the same as BL.

Embodiment 3: Some embodiments may be similar to those discussed with respect to Embodiment 1-2. In these embodiments, alternatively, if base layer mode information is not available, BL mode information is not used for EL MPM list generation, and inputs defined in HEVC WD8 (intraPredModeA and intraPredModeB) are used. Normal HEVC MPM list generation process is performed.

Embodiment 4: Some embodiments may be similar to those discussed with respect to Embodiment 1-3. In these embodiments, alternatively, if base layer mode information is not intra mode, BL mode information is not used for EL MPM list generation, and inputs defined in HEVC WD8 (intraPredModeA and intraPredModeB) are used. Normal HEVC MPM list generation process is performed.

Embodiment 5: Some embodiments may be similar to those discussed with respect to Embodiment 1-4. These embodiments may alternatively include an implementation of SHVC MPM list generation for EL as shown below:

If ((col BL_PREDICTION is available) && col
BL_PREDICTION == INTRA_MODE) {
intraPredModeA = BaseLayerMode
}

Embodiment 6: Some embodiments may be similar to those discussed with respect to Embodiment 1-5. These embodiments may alternatively include an implementation for SHVC MPM list generation for EL as shown below:

If ((col BL_PREDICTION is available) && col
BL_PREDICTION == INTRA_MODE) {
intraPredModeB = BaseLayerMode
}

Embodiment 7: For Embodiment 1-6, the techniques may also apply for chroma component.

Embodiment 8: Some embodiments include multi-view or 3DV extensions of HEVC and similar scalable, multi-view, or 3DV coding scenarios based on any other coding framework, e.g., H.264/AVC.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to code video information, the apparatus comprising:
a memory unit configured to store video information associated with a reference layer and a corresponding enhancement layer; and
a processor in communication with the memory unit, the processor configured to:
receive a mode list associated with the enhancement layer, the mode list comprising three entities, each entity identifying a different mode for determining a value of a video unit located at a position within the enhancement layer; and
change the mode list when a mode associated with a co-located video unit in the reference layer is not stored as the first entity in the mode list;
wherein the co-located video unit is located at a position in the reference layer corresponding to the position of the video unit in the enhancement layer.

2. The apparatus of claim 1, wherein the processor is further configured to refrain from changing the mode list when the mode associated with the co-located video unit is in the mode list.

3. The apparatus of claim 1, wherein the processor is further configured to refrain from changing the mode list when the mode associated with the co-located video unit is a DC mode.

4. The apparatus of claim 1, wherein the processor is further configured to refrain from changing the mode list when the mode associated with the co-located video unit corresponds to a mode in which an average of video unit values in the reference layer is used to determine the video unit value in the enhancement layer.

5. The apparatus of claim 1, wherein the processor is further configured to change the mode list by shifting the mode list entities and storing the mode of the co-located video unit as the first entity in the mode list.

6. The apparatus of claim 1, wherein the processor is further configured to change the mode list when the mode associated with the co-located video unit in the reference layer is not stored in the mode list.

7. The apparatus of claim 1, wherein the processor is further configured to change the mode list when the mode associated with the co-located video unit is stored as the second or third entity of the mode list by swapping its position in the list with the first entity in the mode list.

8. The apparatus of claim 7, wherein the processor is further configured to refrain from changing the mode list when the mode associated with the co-located video unit is a DC mode.

9. The apparatus of claim 7, wherein the processor is further configured to refrain from changing the mode list when the mode associated with the co-located video unit corresponds to a mode in which an average of video unit values in the reference layer is used to determine the video unit value in the enhancement layer.

10. The apparatus of claim 1, wherein changing the mode list includes prioritizing the entities in the mode list based at least in part on the mode associated with the co-located video unit.

11. The apparatus of claim 1, wherein the processor is further configured to change the mode list at a coding level selected from a group comprising: a sequence, a group of frames, frame, a group of slices, slice, a group of coding units (CUs), coding unit (CU), a group of prediction units (PUs), prediction unit (PU), blocks, a region of pixels, and a pixel.

12. The apparatus of claim 1, wherein the processor is further configured to encode the mode list and to signal the mode list in a bitstream of video information.

13. The apparatus of claim 1, wherein the processor is further configured to decode the mode list and to receive the mode list in a bitstream of video information or at least partially derive the mode list based on information in a bitstream of video information.

14. The apparatus of claim 1, wherein the processor is further configured to determine a flag that indicates that an intra prediction mode for the enhancement layer is to be determined from a reference layer intra mode and set the reference layer intra mode to a default intra mode direction when the reference layer intra mode is not available.

15. The apparatus of claim 1, wherein the apparatus is selected from a group consisting of one or more of: a desktop computer, a notebook computer, a laptop computer, a tablet computer, a set-top box, a telephone handset, a smart phone, a smart pad, a television, a camera, a display device, a digital media player, a video gaming console, and a video streaming device.

16. A method of coding video information, the method comprising:
storing video information associated with a reference layer and a corresponding enhancement layer;
receiving a mode list associated with the enhancement layer, the mode list comprising three entities, each entity identifying a different mode for determining a value of a video unit located at a position within the enhancement layer; and
changing the mode list when a mode associated with a co-located video unit in the reference layer is not stored as the first entity in the mode list;
wherein the co-located video unit is located at a position in the reference layer corresponding to the position of the video unit in the enhancement layer.

17. The method of claim 16, further comprising refraining from changing the mode list when the mode associated with the co-located video unit is in the mode list.

18. The method of claim 16, further comprising refraining from changing the mode list when the mode associated with the co-located video unit is a DC mode.

19. The method of claim 16, further comprising refraining from changing the mode list when the mode associated with the co-located video unit corresponds to a mode in which an average of video unit values in the reference layer is used to determine the video unit value in the enhancement layer.

20. The method of claim 16, further comprising changing the mode list by shifting the mode list entities and storing the mode of the co-located video unit as the first entity in the mode list.

21. The method of claim 16, further comprising changing the mode list when the mode associated with the co-located video unit in the reference layer is not stored in the mode list.

22. The method of claim 16, further comprising changing the mode list when the mode associated with the co-located video unit is stored as the second or third entity of the mode list by swapping its position in the list with the first entity in the mode list.

23. The method of claim 22, further comprising refraining from changing the mode list when the mode associated with the co-located video unit is a DC mode.

24. The method of claim 22, further comprising refraining from changing the mode list when the mode associated with the co-located video unit corresponds to a mode in which an average of video unit values in the reference layer is used to determine the video unit value in the enhancement layer.

25. The method of claim 16, wherein changing the mode list includes prioritizing the entities in the mode list based at least in part on the mode associated with the co-located video unit.

26. The method of claim 16, further comprising changing the mode list at a coding level selected from a group comprising: a sequence, a group of frames, frame, a group of slices, slice, a group of coding units (CUs), coding unit (CU), a group of prediction units (PUs), prediction unit (PU), blocks, a region of pixels, and a pixel.

27. The method of claim 16, further comprising encoding the mode list and signaling the mode list in a bitstream of video information.

28. The method of claim 16, further comprising decoding the mode list and receiving the mode list in a bitstream of video information or at least partially derive the mode list based on information in a bitstream of video information.

29. The method of claim 16, further comprising determining a flag that indicates that an intra prediction mode for the enhancement layer is to be determined from a reference layer intra mode and setting the reference layer intra mode to a default intra mode direction when the reference layer intra mode is not available.

30. A non-transitory computer-readable storage medium having instructions stored thereon that when executed cause an apparatus to:
store video information associated with a reference layer and a corresponding enhancement layer; and
receive a mode list associated with the enhancement layer, the mode list comprising three entities, each entity identifying a different mode for determining a value of a video unit located at a position within the enhancement layer; and
change the mode list when a mode associated with a co-located video unit in the reference layer is not stored as the first entity in the mode list;
wherein the co-located video unit is located at a position in the reference layer corresponding to the position of the video unit in the enhancement layer.

31. The computer-readable storage medium of claim 30, further comprising instructions that when executed cause the apparatus to refrain from changing the mode list when the mode associated with the co-located video unit is in the mode list.

32. The computer-readable storage medium of claim 30, further comprising instructions that when executed cause the apparatus to refrain from changing the mode list when the mode associated with the co-located video unit corresponds to a mode in which an average of video unit values in the reference layer is used to determine the video unit value in the enhancement layer.

33. The computer-readable storage medium of claim 30, further comprising instructions that when executed cause the apparatus to change the mode list when the mode associated with the co-located video unit in the reference layer is not stored in the mode list.

34. The computer-readable storage medium of claim 30, wherein changing the mode list includes prioritizing the entities in the mode list based at least in part on the mode associated with the co-located video unit.

35. An apparatus configured to code video information, the apparatus comprising:
means for storing video information associated with a reference layer and a corresponding enhancement layer;
means for receiving a mode list associated with the enhancement layer, the mode list comprising three entities, each entity identifying a different mode for determining a value of a video unit located at a position within the enhancement layer; and
means for changing the mode list when a mode associated with a co-located video unit in the reference layer is not stored as the first entity in the mode list;
wherein the co-located video unit is located at a position in the reference layer corresponding to the position of the video unit in the enhancement layer.

36. The apparatus of claim 35, wherein the means for changing the mode list is further configured to refrain from changing the mode list when the mode associated with the co-located video unit is in the mode list.

37. The apparatus of claim 35, wherein the means for changing the mode list is further configured to refrain from changing the mode list when the mode associated with the co-located video unit corresponds to a mode in which an average of video unit values in the reference layer is used to determine the video unit value in the enhancement layer.

38. The apparatus of claim 35, wherein the means for changing the mode list is further configured to change the mode list when the mode associated with the co-located video unit in the reference layer is not stored in the mode list.

39. The apparatus of claim 35, wherein changing the mode list includes prioritizing the entities in the mode list based at least in part on the mode associated with the co-located video unit.
